(19) United States
(12) Patent Application Publication
(10) Pub. No.: US 2002/0175969 A1
(43) Pub. Date: Nov. 28, 2002

(54) Ink jet recording device

(76) Inventor: Kentaro Suzuki, Chiba-shi (JP)

Correspondence Address: ADAMS & WILKS, 31st Floor, 50 Broadway, New York, NY, 10004, US

(21) Appl. No.: 10/147,416

(22) Filed: May 16, 2002

(30) Foreign Application Priority Data
May 24, 2001 (JP) 2001-155263

(51) Int. Cl. B41J 2/165; B41J 2/175

(52) U.S. Cl. 347/28; 347/85

(57) ABSTRACT

An ink jet recording device is provided, which is capable of improving workability of cleaning and a restoration property of a system after cleaning and carrying out printing in a properly maintained state using ink that requires cleaning at a high frequency. The ink jet recording device, which is provided with a plurality of ink jet head 1A having a plurality of nozzle openings for discharging ink supplied from ink reservoir portions 7 and 11, is further provided with a cleaning liquid supply pipe 6 via an open-close valve 4 separately from an ink supply pipe 5 via an open-close valve 3 in the vicinity of the upper surface of a flow path substrate 2A.

### BACKGROUND OF THE INVENTION

1. Field of the Invention

The present invention relates to an ink jet recording device that has an ink jet head and is applied to, for example, a printer and a plotter.

2. Description of the Related Art

Conventionally, in order to clean the inside of an ink jet head and an ink supply pipe from an ink reservoir portion to the ink jet head, an ink cartridge is replaced with a cleaning liquid cartridge to fill the ink supply pipe and the ink jet head with cleaning liquid while forcing out ink filled between the ink reservoir portion to the ink supply pipe and the ink jet head by sucking the ink. In a small ink jet recording device such as a printer and a facsimile with a relatively short ink flow path from a cartridge to an ink jet head, no critical problem arises in relation to its workability. However, in an ink jet recording device such as a plotter having a stationary ink reservoir portion with a large capacity, a long ink flow path from the ink reservoir portion to an ink jet head and a sub-tank for temporarily holding ink in the middle of an ink supply pipe, there are problems in relation to its workability in that, for example, it is necessary to remove ink in the ink reservoir portion in advance and it takes a long time to replace residual ink in the long flow path with cleaning liquid. Moreover, when the ink is set again after cleaning a system, since the ink tends to be diluted due to an effect of residual cleaning liquid, unnecessary labor such as sufficiently removing the ink is required.

At present, screen printing is generally used for label printing of an optical disk such as a CD and a DVD. According to this screen printing, print patterns that are different for each color are formed on a surface of an optical disk using radiation curable ink such as ultraviolet ray curable ink and electron beam curable ink, whereby an image is printed on the surface of the optical disk. However, in the screen printing using a lithographic plate, since it is necessary to keep a lithographic plate in order to cope with increase in the number of printings and maintenance and the like of the lithographic plate is also required, costs of printing increase. Moreover, an apparatus for carrying out the screen printing is large and requires a broad work space and, at the same time, is expensive. These problems can be solved by using an ink jet recording device having an ink jet head for discharging ink from a plurality of nozzles to carry out printing.

However, the ultraviolet ray curable ink used for the printing on an optical disk such as a CD and a DVD may generate radicals due to an effect such as heat even if ultraviolet rays are not irradiated on it and cause a gelation phenomenon called a dark reaction. In addition, the ultraviolet ray curable ink hinders reserving stability of ink and is susceptible to gelation depending on a pigment. Since the ultraviolet ray curable ink has such properties to which attention should be paid, if it is used in an ink jet recording device, it is necessary to clean an ink jet head and an ink flow path at an appropriate time in order to avoid curing and gelation and facilitate restoration of the system.

In addition, when ink, such as solvent ink, that is likely to cause damages to a material is used, it is necessary to carry out cleaning in the same manner at an appropriate time.

However, in the case of an ink jet recording device, such as label print manufacturing equipment, with a system configuration having a stationary ink reservoir portion with a large capacity, a long ink flow path from the ink reservoir portion to an ink jet head and a sub-tank for temporarily holding ink in the middle of an ink supply pipe, cleaning cannot be carried out at an appropriate time due to the above-described problems.

### SUMMARY OF THE INVENTION

The present invention has been devised in view of the above and other drawbacks, and it is an object of the present invention to provide an ink jet recording device that is capable of carrying out printing in a proper maintenance state using ink such as radiation curable ink and solvent ink that requires cleaning of an ink jet head and an ink flow path at a relatively high frequency.

In order to solve the above-mentioned problem, according to a first aspect of the present invention, there is provided an ink jet recording device provided with an ink reservoir portion and an ink jet head having a plurality of nozzles for discharging ink to be supplied from the ink reservoir portion, which is characterized by comprising: an ink flow path for supplying ink from the ink reservoir portion to the ink jet head; and a cleaning liquid flow path for supplying cleaning liquid to the ink jet head via a route separate from the ink flow path.

According to a second aspect of the present invention, there is provided an ink jet recording device according to the fist aspect of the invention, which is characterized in that the cleaning liquid flow path is connected to the ink jet head independently from the ink flow path.

According to a third aspect of the present invention, there is provided an ink jet recording device according to the first or the second aspect of the invention, which is characterized in that a valve for controlling flow of cleaning liquid is provided in the middle of the cleaning liquid flow path.

According to a forth aspect of the present invention, there is provided an ink jet recording device according to the first aspect of the invention, which is characterized in that the cleaning liquid flow path joins the ink flow path in the middle of the cleaning liquid flow path.

According to a fifth aspect of the present invention, there is provided an ink jet recording device according to the forth aspect of the invention, which is characterized in that a switching means is provided for selecting inflow of one of ink and cleaning liquid in a location where the cleaning liquid flow path joins the ink flow path.

### BRIEF DESCRIPTION OF THE DRAWINGS

For a more better understanding of the present invention, reference is made of a detailed description to be read in conjunction with the accompanying drawings, in which:

FIG. 1 is a schematic diagram showing constructions of an ink jet head, an ink tank and the like in accordance with a first embodiment of the present invention;

FIG. 2 is a disassembled perspective view and a main part enlarged view of a head chip in accordance with the first embodiment of the present invention;

FIG. 3 is a schematic diagram of a construction of the ink jet head in accordance with the first embodiment of the present invention;

FIG. 4 is a schematic diagram of a construction of an ink jet head in accordance with a second embodiment of the present invention; and

FIG. 5 is a perspective view of an inkjet head unit in accordance with the second embodiment of the present invention.

### DETAILED DESCRIPTION OF THE PREFERED EMBODIMENT

The present invention will be hereinafter described in detail based on embodiments of the present invention. It is needless to mention that the present invention is not limited to these embodiments.

(First Embodiment)

A first embodiment is an ink jet recording device of a stationary head type using a large line-type ink jet head.

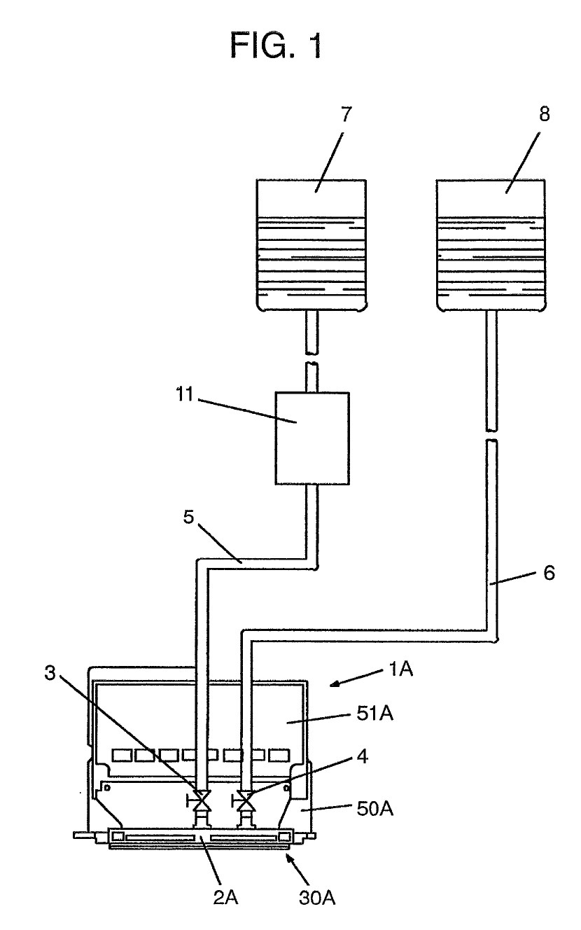

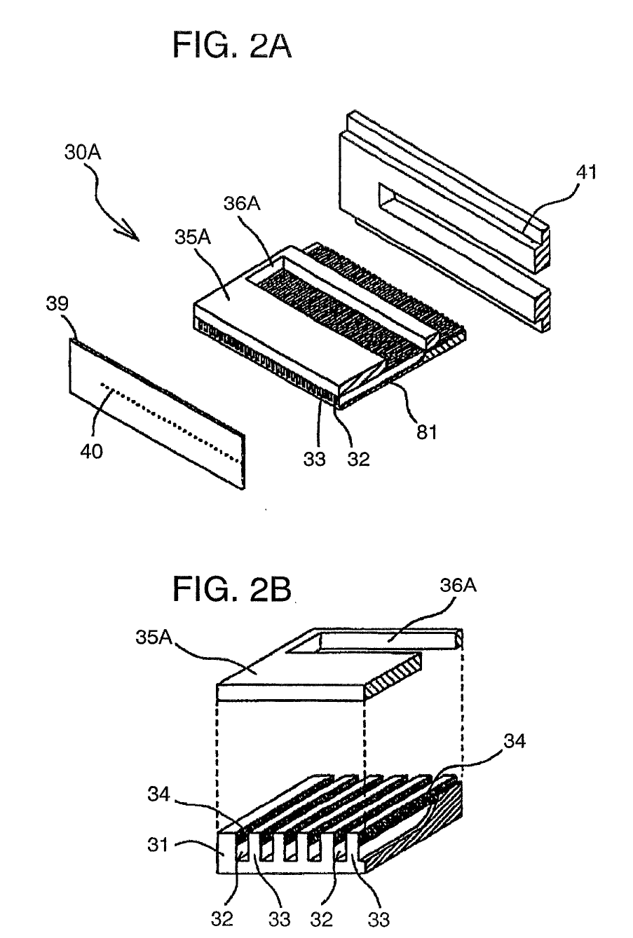

FIG. 1 is a schematic diagram showing constructions of an ink jet head, an ink tank and the like in accordance with the first embodiment, and FIG. 2 is a disassembled perspective view of a head chip forming the ink jet head.

As shown in the figure, an ink jet head 1A of this embodiment has a head chip 30A, a flow path substrate 2A provided on one surface side of the head chip 30A and a wiring substrate 51A mounted with a driving circuit and the like for driving the head chip 30A. Each of these members is fixed on a base plate 50A.

The head chip 30A is provided with a piezoelectric ceramic plate 31, a nozzle plate 39, a nozzle support plate 41 and an ink chamber plate 35A. The ink chamber plate 35A is provided with a common ink chamber 36A formed through it over the entirety of grooves 32 provided in parallel with each other.

In addition, the flow path substrate 2A is joined to one surface of the ink chamber plate 35A, thereby sealing one surface of the common ink chamber 36A by this flow path substrate 2A. More specifically, this flow path substrate 2A abuts with one surface of the ink chamber plate 35A via an O ring or the like and is fixed to the base plate 50A by not-shown screw members or the like.

Further, an open-close valve 3 for controlling flow of ink is provided in the vicinity of the upper surface of the flow path substrate 2A. An ink supply pipe 5 formed of a stainless steel pipe or the like is connected to the flow path substrate 2A via the open-close valve 3. A sub-tank 11 is connected to the other end side of the ink supply pipe 5. An ink tank 7 is connected to the sub-tank 11 to form an ink reservoir portion.

In this way, ink supplied from the ink tank 7 is temporarily held in the sub-tank 11 and thereafter supplied to the head chip 30A through the flow path substrate 2A via the ink supply pipe 5. At this point, an open-close valve 4 for controlling flow of cleaning liquid to be described later is in a closed state.

In addition, a pipe path for supplying cleaning liquid to the flow path substrate 2A is provided in parallel with the above-mentioned ink supply pipe. The open-close valve 4 for controlling flow of cleaning liquid is provided in the vicinity of the upper surface of the flow path substrate 2A in the same manner as the ink supply pipe. A cleaning liquid supply pipe 6 formed of a stainless steel pipe or the like is connected to the flow path substrate 2A via the open-close valve 4. A cleaning liquid tank 8 is connected to the other end side of the cleaning liquid supply pipe 6.

Cleaning liquid supplied from the cleaning liquid tank 8 is sucked by a not-shown suction unit to clean the inside of the ink jet head. At this point, the open-close valve 4 for controlling flow of cleaning liquid is in an open state and the open-close valve 3 for controlling flow of ink is in a closed state.

In this way, a dedicated flow path for cleaning liquid is provided in parallel with an ink flow path in the vicinity of a flow path substrate. As a result, even in an ink jet recording device, such as label print manufacturing equipment, with a system configuration having a stationary ink reservoir portion with a large capacity, a long ink flow path from the ink reservoir portion to an ink jet head and a sub-tank for temporarily holding ink in the middle of an ink supply pipe, printing can be carried out in a proper maintenance state using ink such as radiation curable ink and solvent ink that requires cleaning of an ink jet head and the like at a relatively high frequency in order to avoid curing and gelation in the ink jet head and the ink flow path.

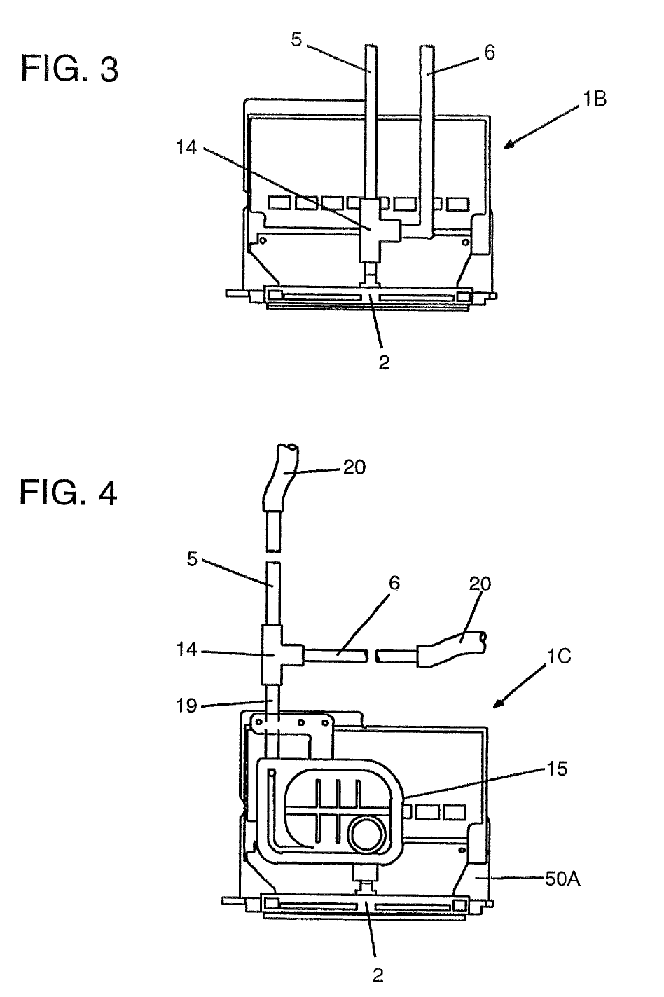

Note that, although an ink flow path and a cleaning liquid flow path are provided in parallel with each other on a flow path substrate in this embodiment, the present invention is not limited to this configuration and may be given the same function using a three-way valve 14 or the like as shown in FIG. 3. In any case, a cleaning liquid flow path is provided separately from an ink flow path, whereby workability of cleaning and a restoration property after cleaning can be improved and an ink jet recording device that uses radiation curable ink and solvent ink and is excellent in maintainability can be provided.

(Second Embodiment)

In the above-described first embodiment, an ink jet recording device of a stationary head type using a large line type ink jet head is illustrated. In a second embodiment, an ink jet recording device of a serial type and the like using a large ink jet head will be described.

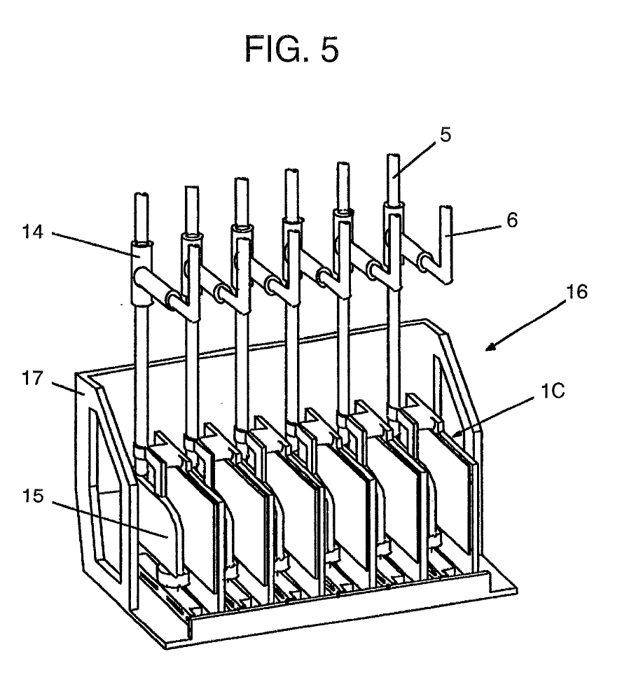

FIG. 4 is a schematic diagram of a construction of an ink jet head in accordance with the second embodiment. FIG. 5 is a perspective view of an ink jet head unit.

As shown in FIGS. 4 and 5, in an ink jet head 1C of this embodiment, an air damper 15 held by a base plate 50A is provided between a supply pipe 19 and a flow path substrate 2, a three-way valve 14 is attached to the other end of the supply pipe, and an ink supply pipe 5 and a cleaning liquid supply pipe 6 are attached to the three-way valve 14. A plurality of ink jet heads 1C are mounted in a main scanning direction on a carriage 17, which is movably provided in the main scanning direction, to configure an ink jet head unit 16. The ink jet head 1C is the same as that of the above-mentioned first embodiment except that a not-shown ink tank and a cleaning liquid tank are connected to the ink supply pipe 5 and the cleaning liquid supply pipe 6, respectively, on the other side of the three-way valve 14 via flexible tubes 20 made of rubber, plastics or the like.

In addition, the air damper 15 is a member for adjusting a negative pressure of ink to be supplied when the ink jet head 1C moves in the main scanning direction. The air damper 15 also requires cleaning at an appropriate time in the same manner as an ink jet head, an ink flow path and the like such that curing and gelation of radiation curing ink and the like do not occur in it.

In this way, in an ink jet recording device of a serial type, a cleaning liquid supply pipe is provided in the vicinity of the upper surface of the air damper 15 separately from the ink supply pipe 5 via the three-way valve 14, whereby workability of cleaning and a restoration property after cleaning can also be improved and an ink jet recording device that uses radiation curable ink and solvent ink and is excellent in maintainability can be provided.

As described above, according to the present invention, a cleaning liquid flow path is provided separately from an ink flow path, whereby workability of cleaning and a restoration property after cleaning can be improved and an ink jet recording device that uses radiation curable ink and solvent ink, which require cleaning of an ink jet head and an ink flow path at a relatively high frequency in order to avoid curing and gelation in the ink jet head and the ink flow path and is excellent in maintainability, can be provided.

What is claimed is:

1. An ink jet recording device comprising:
an ink reservoir portion storing an ink;
an ink jet head having a plurality of nozzles for discharging ink to be supplied from the ink reservoir portion;
an ink flow path for supplying ink from said ink reservoir portion to said ink jet head; and
a cleaning liquid flow path for supplying cleaning liquid to said ink jet head via a route separate from the ink flow path.

2. An ink jet recording device according to claim 1, wherein the cleaning liquid flow path is connected to said ink jet head independently from the ink flow path.

3. An ink jet recording device according to claim 1, further comprising a valve for controlling flow of cleaning liquid is provided in the middle of the cleaning liquid flow path.

4. An ink jet recording device according to claim 1, wherein the cleaning liquid flow path joins the ink flow path in the middle of the cleaning liquid flow path.

5. An ink jet recording device according to claim 4, further comprising a switching means for selecting inflow of one of ink and cleaning liquid in a location where the cleaning liquid flow path joins the ink flow path.
